(19) United States
(12) Patent Application Publication
(10) Pub. No.: US 2022/0066135 A1
(43) Pub. Date: Mar. 3, 2022

(54) CAMERA OPTICAL LENS

(71) Applicant: AAC Optics (Changzhou) Co., Ltd., Changzhou City (CN)

(72) Inventors: Wen Sun, Shenzhen (CN); Jia Chen, Shenzhen (CN)

(21) Appl. No.: 17/134,173

(22) Filed: Dec. 25, 2020

(30) Foreign Application Priority Data
Aug. 26, 2020 (CN) 202010866922.6

(51) Int. Cl. G02B 9/60; G02B 13/18

(52) U.S. Cl. CPC G02B 9/60; G02B 13/18

(57) ABSTRACT

The present invention relates to the field of optical lenses, and provides a camera optical lens, including five lenses, which are, from an object side to an image side, a first lens having a positive refractive power, a second lens having a negative refractive power, a third lens having a positive refractive power, a fourth lens having a positive refractive power, and a fifth lens having a negative refractive power. At least one of the first lens to the fifth lens has a free-form surface, and a central curvature radius of an image side surface of the second lens is R4 satisfying R4≤0. The camera optical lens according to the present invention satisfies the design requirements of ultra-thinness, a wide angle, and a large aperture, as well as excellent optical performance.

### TECHNICAL FIELD

The present invention relates to the field of optical lenses, and more particularly, to a camera optical lens suitable for portable terminal devices such as smart phones and digital cameras, and for imaging devices such as monitors and PC lenses.

### BACKGROUND

With the development of camera lenses, higher and higher requirements are put forward for imaging quality of the lenses. The “night scene photography” and “bokeh” of the lens have also become important indexes to measure the imaging performances of the lens. At present, rotationally symmetric aspherical surfaces are mostly used. Such an aspherical surface has a sufficient degree of freedom only in a meridian plane, and cannot well correct off-axis aberration. The existing structures have insufficient refractive power allocation, lens spacing and lens shape settings, resulting in insufficient ultra-thinness and wide angle of the lenses. A free-form surface is a non-rotationally symmetric surface, which can better balance aberration and improve the imaging quality; besides, processing of the free-form surface has gradually become mature. With the increasing requirements for imaging of the lens, it is very important to provide a free-form surface in the design of a lens, especially in the design of wide-angle and ultra-wide-angle lenses.

### SUMMARY

In view of the above-mentioned problems, a purpose of the present invention is to provide a camera optical lens, which has a large aperture, a wide angle and ultra-thinness, as well as excellent optical performance.

In order to solve the above-mentioned technical problem, an embodiment of the present invention provide a camera optical lens, including, from an object side to an image side, a first lens having a positive refractive power, a second lens having a negative refractive power, a third lens having a positive refractive power, a fourth lens having a positive refractive power, and a fifth lens having a negative refractive power. At least one of the first lens to the fifth lens has a free-form surface, and the camera optical lens satisfies a following condition: R4≤0, where R4 is a central curvature radius of an image side surface of the second lens.

In an improved embodiment, the camera optical lens further satisfies a following condition: 1.50≤d5/d4≤11.00, where d4 is an on-axis distance from the image side surface of the second lens to an object side surface of the third lens, and d5 is an on-axis thickness of the third lens.

In an improved embodiment, the camera optical lens further satisfies following conditions: 0.48≤f1/f≤1.51; −3.74≤(R1+R2)/(R1−R2)≤−1.02; and 0.05≤d1/TTL≤0.21, where f is a focal length of the entire camera optical lens, f1 is a focal length of the first lens, R1 is a central curvature radius of an object side surface of the first lens, R2 is a central curvature radius of an image side surface of the first lens, d1 is an on-axis thickness of the first lens, and TTL is a total optical length from the object side surface of the first lens to an image plane of the camera optical lens along an optic axis.

In an improved embodiment, the camera optical lens further satisfies following conditions: −4.62≤f2/f≤−1.29; −3.06≤(R3+R4)/(R3−R4)≤−0.73; and 0.02≤d3/TTL≤0.07, where f is a focal length of the camera optical lens, f2 is a focal length of the second lens, R3 is a central curvature radius of an object side surface of the second lens, d3 is an on-axis thickness of the second lens, and TTL is a total optical length from an object side surface of the first lens to an image plane of the camera optical lens along an optic axis.

In an improved embodiment, the camera optical lens further satisfies: 1.27≤f3/f≤6.73; −3.58≤(R5+R6)/(R5−R6)≤−0.07; and 0.04≤d5/TTL≤0.24, where f is a focal length of the camera optical lens, f3 is a focal length of the third lens, R5 is a central curvature radius of an object side surface of the third lens, R6 is a central curvature radius of an image side surface of the third lens, d5 is an on-axis thickness of the third lens, and TTL is a total optical length from an object side surface of the first lens to an image plane of the camera optical lens along an optic axis.

In an improved embodiment, the camera optical lens further satisfies following conditions: 0.53≤f4/f≤5.63; 0.70≤(R7+R8)/(R7−R8)≤2.58; and 0.06≤d7/TTL≤0.19, where f is a focal length of the camera optical lens, f4 is a focal length of the fourth lens, R7 is a central curvature radius of an object side surface of the fourth lens, R8 is a central curvature radius of an image side surface of the fourth lens, d7 is an on-axis thickness of the fourth lens, and TTL is a total optical length from an object side surface of the first lens to an image plane of the camera optical lens along an optic axis.

In an improved embodiment, the camera optical lens further satisfies: −3.23≤f5/f≤−0.54; 0.89≤(R9+R10)/(R9−R10)≤4.98; and 0.05≤d9/TTL≤0.24, where f is a focal length of the camera optical lens, f5 is a focal length of the fifth lens, R9 is a central curvature radius of an object side surface of the fifth lens, R10 is a central curvature radius of an image side surface of the fifth lens, d9 is an on-axis thickness of the fifth lens, and TTL is a total optical length from an object side surface of the first lens to an image plane of the camera optical lens along an optic axis.

In an improved embodiment, the camera optical lens further satisfies a following condition: TTL/IH≤1.60, where TTL is a total optical length from an object side surface of the first lens to an image plane of the camera optical lens along an optic axis, and IH is an image height of the camera optical lens.

In an improved embodiment, the camera optical lens further satisfies a following condition: FOV≥77°, where FOV is a field of view of the camera optical lens. In an improved embodiment, the camera optical lens further satisfies: FNO≤2.21, where FNO is an F number of the camera optical lens.

The beneficial effects of the present invention are as follows. The camera optical lens according to the present invention has a large aperture, a wide angle and ultra-thinness, as well as excellent optical performance. Meanwhile, at least one of the first lens to the fifth lens has a free-form surface, which is beneficial to correct distortion and field curvature of the system and improve the imaging quality, and is especially suitable for mobile phone camera lens assembly and WEB camera lens composed of imaging elements such as CCD and CMOS used for high pixels.

### BRIEF DESCRIPTION OF DRAWINGS

In order to more clearly illustrate technical solutions in embodiments of the present invention, the accompanying drawings used in the embodiments are briefly introduced as follows. It should be noted that the drawings described as follows are merely part of the embodiments of the present invention, and other drawings can also be acquired by those skilled in the art without paying creative efforts.

FIG. 1 is a schematic structural diagram of a camera optical lens according to Embodiment 1 of the present invention;

FIG. 2 illustrates a situation where RMS spot diameter of the camera optical lens shown in FIG. 1 is within a first quadrant;

FIG. 3 is a schematic structural diagram of a camera optical lens according to Embodiment 2 of the present invention;

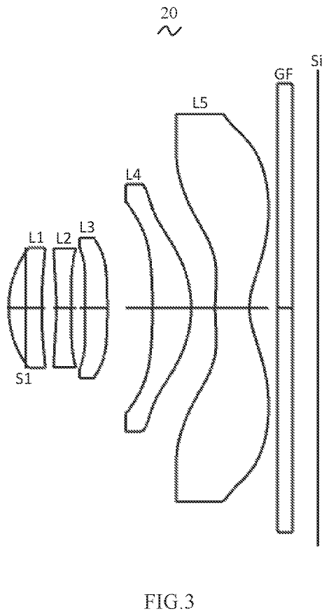

FIG. 4 illustrates a situation where RMS spot diameter of the camera optical lens shown in FIG. 3 is within a first quadrant;

FIG. 5 is a schematic structural diagram of a camera optical lens according to Embodiment 3 of the present invention;

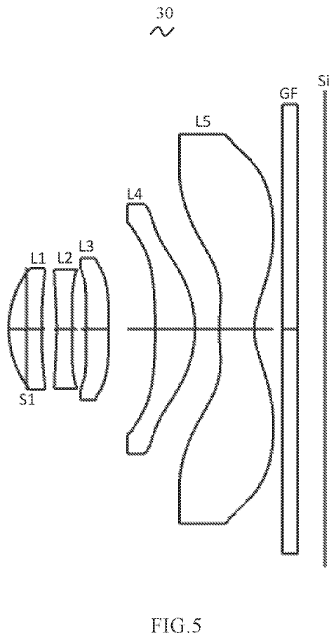

FIG. 6 illustrates a situation where RMS spot diameter of the camera optical lens shown in FIG. 5 is within a first quadrant;

FIG. 7 is a schematic structural diagram of a camera optical lens according to Embodiment 4 of the present invention;

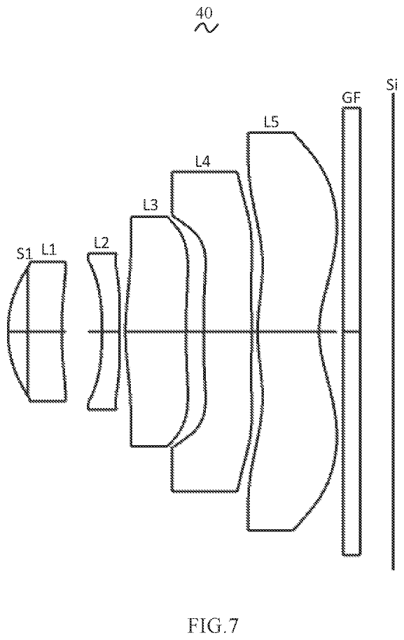

FIG. 8 illustrates a situation where RMS spot diameter of the camera optical lens shown in FIG. 7 is within a first quadrant;

FIG. 9 is a schematic structural diagram of a camera optical lens according to Embodiment 5 of the present invention; and

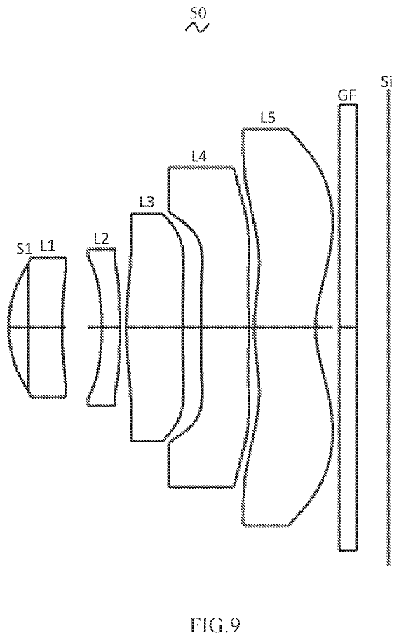

FIG. 10 illustrates a situation where RMS spot diameter of the camera optical lens shown in FIG. 9 is within a first quadrant.

### DESCRIPTION OF EMBODIMENTS

The present invention will hereinafter be described in detail with reference to several exemplary embodiments. To make the technical problems to be solved, technical solutions and beneficial effects of the present invention more apparent, the present invention is described in further detail together with the figures and the embodiments. It should be understood the specific embodiments described hereby is only to explain the invention, not intended to limit the invention.

### Embodiment 1

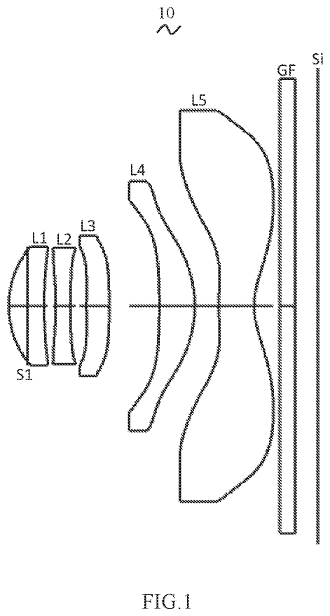

With reference to the accompanying drawings, the present invention provides a camera optical lens 10. FIG. 1 illustrates a camera optical lens 10 according to Embodiment 1 of the present invention. The camera optical lens 10 includes five lenses. Specifically, the camera optical lens 10 includes, from an object side to an image side, an aperture S1, a first lens L1, a second lens L2, a third lens L3, a fourth lens L4, and a fifth lens L5. Optical elements such as an optical filter GF may be arranged between the fifth lens L5 and an image surface Si.

In this embodiment, the first lens L1 is made of a plastic material, the second lens L2 is made of a plastic material, the third lens L3 is made of a plastic material, the fourth lens L4 is made of a plastic material, and the fifth lens L5 is made of a plastic material. In other embodiments, the lenses may be made of other materials.

In this embodiment, at least one of the first lens L1 to the fifth lens L5 includes a free-form surface, and the free-form surface is beneficial to correct distortion and field curvature of the system, and improve imaging quality.

In this embodiment, the first lens L1 has a positive refractive power, a focal length range of the first lens is defined, and then it is beneficial to achieve a wide angle of the system within a conditional range.

In this embodiment, the second lens L2 has a negative refractive power, a focal length range of the second lens is defined, and then it is beneficial to improve the imaging performance of the system within a condition al range.

In this embodiment, the third lens L3 has a positive refractive power, a focal length range of the third lens is defined, and then it is beneficial to improve the imaging quality within a conditional range.

In this embodiment, the fourth lens L4 has a positive refractive power, a focal length range of the fourth lens is defined, and then it is beneficial to improve the imaging performance of the system within a conditional range.

It is defined that a central curvature radius of an image side surface of the second lens L2 is R4, and the camera optical lens satisfies the following condition: R4≤0, which defines a shape of the second lens. Within a range defined by this condition, it is beneficial to correct field curvature of the system and improve the image quality.

It is defined that an on-axis distance from the image side surface of the second lens L2 to an object side surface of the third lens L3 is d4, and an on-axis thickness of the third lens L3 is d5, and the camera optical lens satisfies the following condition: 1.50≤d5/d4≤11.00. Within a range defined by this condition, it is beneficial to reduce a total length of the system.

In this embodiment, an object side surface of the first lens L1 is a convex surface at a paraxial position, and an image side surface of the first lens L1 is a concave surface at a paraxial position.

It is defined that a focal length of the first lens L1 is f1, and a focal length of the entire camera optical lens 10 is f, and the camera optical lens satisfies the following condition: 0.48≤f1/f≤1.51, which defines a ratio of the focal length of the first lens L1 to the focal length of the entire camera optical lens. Within a range defined by this condition, the first lens has an appropriate positive refractive power, which is beneficial to reduce aberration of the system, while achieving ultra-thinness and wide-angle of the camera optical lens. As an example, the camera optical lens satisfies the following condition: 0.77≤f1/f≤1.21.

A central curvature radius of the object side surface of the first lens L1 is R1, a central curvature radius of the image side surface of the first lens L1 is R2, and the camera optical lens satisfies the following condition: −3.74≤(R1+R2)/(R1−R2)≤−1.02. By reasonably controlling a shape of the first lens L1, the first lens L1 can effectively correct spherical aberration of the system. As an example, the camera optical lens satisfies the following condition: −2.34≤(R1+R2)/(R1−R2)≤−1.27.

An on-axis thickness of the first lens L1 is d1, a total optical length of the camera optical lens 10 is TTL, and the camera optical lens satisfies the following condition: 0.05≤d1/TTL≤0.21. Within a range defined by this condition, it is beneficial to achieve ultra-thinness. As an example, the camera optical lens satisfies the following condition: 0.08≤d1/TTL≤0.17.

In this embodiment, the object side surface of the second lens L2 is a concave surface at a paraxial position, and the image side surface of the second lens L2 is a convex surface at a paraxial position.

It is defined that a focal length of the second lens L2 is f2, a focal length of the entire camera optical lens 10 is f, and the camera optical lens satisfies the following condition: −4.62≤f2/f≤−1.29. By controlling the negative refractive power of the second lens L2 within a reasonable range, it is beneficial to correcting aberration of the optical system. As an example, the camera optical lens satisfies the following condition: −2.89≤f2/f≤−1.61.

A central curvature radius of the object side surface of the second lens L2 is R3, a central curvature radius of the image side surface of the second lens L2 is R4, and the camera optical lens satisfies the following condition: −3.06≤(R3+R4)/(R3−R4)≤−0.73, which defines a shape of the second lens L2. Within a range defined by this condition, with development of ultra-thinness and wide-angle of the camera optical lens, it is beneficial to correcting longitudinal aberration. As an example, the camera optical lens satisfies the following condition: −1.91≤(R3+R4)/(R3−R4)≤−0.92.

An on-axis thickness of the second lens L2 is d3, a total optical length of the camera optical lens 10 is TTL, and the camera optical lens satisfies the following condition: 0.02≤d3/TTL≤0.07. Within a range defined by this condition, it is beneficial to achieve ultra-thinness. As an example, the camera optical lens satisfies the following condition: 0.04≤d3/TTL≤0.06.

In this embodiment, the object side surface of the third lens L3 is a convex surface at a paraxial position, and the image side surface of the third lens L3 is a convex surface at a paraxial position.

It is defined that a focal length of the third lens L3 is f3, a focal length of the entire camera optical lens 10 is f, and the camera optical lens satisfies the following condition: 1.27≤f3/f≤6.73. Reasonable power allocation enables the system to have better imaging quality and lower sensitivity. As an example, the camera optical lens satisfies the following condition: 2.03≤f3/f≤5.39.

A central curvature radius of the object side surface of the third lens L3 is R5, a central curvature radius of the image side surface of the third lens L3 is R6, and the camera optical lens satisfies the following condition: −3.58≤(R5+R6)/(R5−R6)≤−0.07, which defines a shape of the third lens. Within a range defined by this condition, it is beneficial to alleviate a degree of deflection of light passing through the lens and effectively reduce aberration. As an example, the camera optical lens satisfies the following condition: −2.24≤(R5+R6)/(R5−R6)≤−0.09.

An on-axis thickness of the third lens L3 is d5, a total optical length of the camera optical lens 10 is TTL, and the camera optical lens satisfies the following condition: 0.04≤d5/TTL≤0.24. Within a range defined by this condition, it is beneficial to achieve ultra-thinness. As an example, the camera optical lens satisfies the following condition: 0.06≤d5/TTL≤0.19.

In this embodiment, the object side surface of the fourth lens L4 is a concave surface at the paraxial position, and the image side surface of the fourth lens L4 is a convex surface at the paraxial position.

It is defined that a focal length of the fourth lens L4 is f4, a focal length of the entire camera optical lens 10 is f, and the camera optical lens satisfies the following condition: 0.53≤f4/f≤5.63, which defines a ratio of the focal length of the fourth lens to the focal length of the system. Within a range defined by this condition, it is beneficial to improve the performance of the optical system. As an example, the camera optical lens satisfies the following condition: 0.84≤f4/f≤4.51.

A central curvature radius of the object side surface of the fourth lens L4 is R7, a central curvature radius of the image side surface of the fourth lens L4 is R8, and the camera optical lens satisfies the following condition: 0.70≤(R7+R8)/(R7−R8)≤2.58, which defines a shape of the fourth lens L4. Within a range defined by this condition, with the development of ultra-thinness and wide angle, it is beneficial to correct off-axis aberration. As an example, the camera optical lens satisfies the following condition: 1.12≤(R7+R8)/(R7−R8)≤2.07.

An on-axis thickness of the fourth lens L4 is d7, a total optical length of the camera optical lens 10 is TTL, and the camera optical lens satisfies the following condition: 0.06≤d7/TTL≤0.19. Within a range defined by this condition, it is beneficial to achieve ultra-thinness. As an example, the camera optical lens satisfies the following condition: 0.09≤d7/TTL≤0.15.

In this embodiment, the fifth lens L5 has a negative refractive power, the object side of the fifth lens L5 is a convex surface at a paraxial position, and the image side surface of the fifth lens L5 is a concave surface at a paraxial position.

It is defined that a focal length of the fifth lens L5 is f5, a focal length of the entire camera optical lens 10 is f, and the camera optical lens satisfies the following condition: −3.23≤f5/f≤−0.54. The limitation on the fifth lens L5 can effectively smooth a light angle of the camera lens and reduce tolerance sensitivity. As an example, the camera optical lens satisfies the following condition: −2.02≤f5/f≤−0.67.

A central curvature radius of the object side surface of the fifth lens is R9, a central curvature radius of the image side surface of the fifth lens is R10, and the camera optical lens satisfies the following condition: 0.89≤(R9+R10)/(R9−R10)≤4.98, which defines a shape of the fifth lens L5. Within a range defined by this condition, with the development of ultra-thinness and wide angle, it is beneficial to correct off-axis aberration. As an example, the camera optical lens satisfies the following condition: 1.42≤(R9+R10)/(R9−R10)≤3.98.

An on-axis thickness of the fifth lens L5 is d9, a total optical length of the camera optical lens 10 is TTL, and the camera optical lens satisfies the following condition: 0.05≤d9/TTL≤0.24. Within a range defined by this condition, it is beneficial to achieve ultra-thinness. As an example, the camera optical lens satisfies the following condition: 0.09≤d9/TTL≤0.19.

In this embodiment, the total optical length of the camera optical lens 10 is TTL, an image height of the camera optical lens 10 is IH, and the camera optical lens satisfies the following condition: TTL/IH≤1.60, thereby achieving ultra-thinness.

In this embodiment, the field of view of the camera optical lens is FOV, which satisfies the following condition: FOV≥77°, thereby achieving a wide angle.

In this embodiment, an F number FNO of the camera optical lens 10 is smaller than or equal to 2.21. This large aperture leads to good imaging performance.

When the above-mentioned conditions are satisfied, the camera optical lens 10 has good optical performance, and because the free-form surface is adopted, the designed image surface area can be matched with an actual use area, thereby improving the image quality of the effective area to the greatest extent; and based on the characteristics of the camera optical lens 10, the camera optical lens 10 is especially suitable for a mobile phone camera lens assembly and a WEB camera lens composed of imaging elements such as CCD and CMOS for high pixels.

The camera optical lens 10 of the present invention will be described below with the following examples. The symbols described in each example are as follows. The unit of each of the focal length, the on-axis distance, the central curvature radius, and the on-axis thickness is mm.

TTL: a total optical length (an on-axis distance from the object side surface of the first lens L1 to the image plane), with a unit of mm.

F number (FNO): a ratio of an effective focal length of the camera optical lens to an entrance pupil diameter.

Table 1 and Table 2 show design data of the camera optical lens 10 according to the Embodiment 1 of the present invention. Herein, the object side surface and image side surface of the fifth lens L5 are free-form surfaces.

TABLE 1

| | R | d | | nd | | vd | |
|---|---|---|---|---|---|---|---|
| S1 | ∞ | d0 = | −0.257 | | | | |
| R1 | 1.448 | d1 = | 0.488 | nd1 | 1.5444 | v1 | 55.82 |
| R2 | 6.693 | d2 = | 0.162 | | | | |
| R3 | −4.438 | d3 = | 0.210 | nd2 | 1.6700 | v2 | 19.39 |
| R4 | −39.884 | d4 = | 0.212 | | | | |
| R5 | 15.050 | d5 = | 0.319 | nd3 | 1.5444 | v3 | 55.82 |
| R6 | −18.769 | d6 = | 0.694 | | | | |
| R7 | −9.825 | d7 = | 0.491 | nd4 | 1.5444 | v4 | 55.82 |
| R8 | −1.769 | d8 = | 0.331 | | | | |
| R9 | 3.888 | d9 = | 0.488 | nd5 | 1.5444 | v5 | 55.82 |
| R10 | 1.084 | d10 = | 0.355 | | | | |
| R11 | ∞ | d11 = | 0.210 | ndg | 1.5168 | vg | 64.17 |
| R12 | ∞ | d12 = | 0.322 | | | | |

Herein, the representation of each reference sign is as follows.

S1: aperture;

R: curvature radius at a center of an optical surface;

R1: central curvature radius of an object side surface of a first lens L1;

R2: central curvature radius of an image side surface of the first lens L1;

R3: central curvature radius of an object side surface of a second lens L2;

R4: central curvature radius of an image side surface of the second lens L2;

R5: central curvature radius of an object side surface of a third lens L3;

R6: central curvature radius of an image side surface of the third lens L3;

R7: central curvature radius of an object side surface of a fourth lens L4;

R8: central curvature radius of an image side surface of the fourth lens L4;

R9: central curvature radius of an object side surface of a fifth lens L5;

R10: central curvature radius of an image side surface of the fifth lens L5;

R11: central curvature radius of an object side surface of an optical filter GF;

R12: central curvature radius of an image side surface of the optical filter GF;

d: on-axis thickness of a lens, on-axis distance between lenses;

d0: on-axis distance from the aperture S1 to the object side surface of the first lens L1;

d1: on-axis thickness of the first lens L1;

d2: on-axis distance from the image side surface of the first lens L1 to the object side surface of the second lens L2;

d3: on-axis thickness of the second lens L2;

d4: on-axis distance from the image side surface of the second lens L2 to the object side surface of the third lens L3;

d5: on-axis thickness of the third lens L3;

d6: on-axis distance from the image side surface of the third lens L3 to the object side surface of the fourth lens L4;

d7: on-axis thickness of the fourth lens L4;

d8: on-axis distance from the image side surface of the fourth lens L4 to the object side surface of the fifth lens L5;

d9: on-axis thickness of the fifth lens L5;

d10: on-axis distance from an image side surface of the fifth lens L5 to an object side surface of the optical filter GF;

d11: on-axis thickness of the optical filter GF;

d12: on-axis distance from an image side surface of the optical filter GF to an image plane;

nd: refractive index of d-line;

nd1: refractive index of d-line of the first lens L1;

nd2: refractive index of d-line of the second lens L2;

nd3: refractive index of d-line of the third lens L3;

nd4: refractive index of d-line of the fourth lens L4;

nd5: refractive index of d-line of the fifth lens L5;

ndg: refractive index of d-line of the optical filter GF;

vd: abbe number;

v1: abbe number of the first lens L1;

v2: abbe number of the second lens L2;

v3: abbe number of the third lens L3;

v4: abbe number of the fourth lens L4;

v5: abbe number of the fifth lens L5;

vg: abbe number of the optical filter GF.

Table 2 shows aspherical data of the respective lenses in the camera optical lens 10 according to the Embodiment 1 of the present invention.

TABLE 2

| | Cone coefficient | Aspherical coefficient | | | | |
|---|---|---|---|---|---|---|
| | k | A4 | A6 | A8 | A10 | A12 |
| R1 | 1.1462E − 01 | −1.5892E − 03 | 1.1466E − 01 | −9.0119E − 01 | 4.3293E + 00 | −1.2315E + 01 |
| R2 | 2.0066E + 01 | 2.5123E − 03 | −1.6572E − 01 | 1.8795E + 00 | −1.1424E + 01 | 4.1600E + 01 |
| R3 | −1.4268E + 02 | −4.7478E − 02 | 1.5330E − 01 | 1.3352E + 00 | −1.0350E + 01 | 3.7379E + 01 |
| R4 | 2.0000E + 03 | 1.5061E − 01 | −2.6156E − 01 | 2.9539E + 00 | −1.7507E + 01 | 6.0651E + 01 |
| R5 | −1.1719E + 02 | −1.9533E − 01 | 6.7371E − 01 | −5.3622E + 00 | 2.6890E + 01 | −8.9161E + 01 |
| R6 | 3.1432E + 02 | −1.3914E − 01 | 2.7867E − 01 | −1.6927E + 00 | 6.0177E + 00 | −1.4446E + 01 |
| R7 | 3.4456E + 01 | −2.5132E − 03 | −8.0381E − 03 | −2.0764E − 01 | 4.7397E − 01 | −5.2417E − 01 |
| R8 | −1.6242E − 01 | 2.0195E − 02 | −6.8285E − 04 | −6.8019E − 02 | 1.1631E − 01 | −7.3140E − 02 |
| | k | A14 | A16 | A18 | A20 | |
| R1 | 1.1462E − 01 | 2.1409E + 01 | −2.2330E + 01 | 1.2879E + 01 | −3.1854E + 00 | |
| R2 | 2.0066E + 01 | −9.2274E + 01 | 1.2076E + 02 | −8.5408E + 01 | 2.5023E + 01 | |
| R3 | −1.4268E + 02 | −8.1120E + 01 | 1.0557E + 02 | −7.5179E + 01 | 2.2304E + 01 | |
| R4 | 2.0000E + 03 | −1.2679E + 02 | 1.5704E + 02 | −1.0560E + 02 | 2.9725E + 01 | |
| R5 | −1.1719E + 02 | 1.8692E + 02 | −2.3708E + 02 | 1.6486E + 02 | −4.7794E + 01 | |
| R6 | 3.1432E + 02 | 2.2411E + 01 | −2.1278E + 01 | 1.1125E + 01 | −2.4075E + 00 | |
| R7 | 3.4456E + 01 | 3.2930E − 01 | −1.2012E − 01 | 2.4088E − 02 | −2.0879E − 03 | |
| R8 | −1.6242E − 01 | 2.3854E − 02 | −4.3510E − 03 | 4.2674E − 04 | −1.7814E − 05 | |

z=(cr²)/{1+[1−(k+1)(c²r²)]^{1/2}}+A4r⁴+A6r⁶+A8r⁸+A10r¹⁰+A12r¹²+A14r¹⁴+A16r¹⁶+A18r¹⁸+A20r²⁰ (1)

Herein, k represents a cone coefficient, A4, A6, A8, A10, A12, A14, A16, A18, and A20 represent aspherical coefficients, c represents a curvature at a center of an optical surface, r represents a vertical distance between a point on an aspherical curve and an optic axis, Z represents an aspherical depth (a vertical distance between a point on the aspherical surface that is distanced from the optic axis by r and a surface tangent to a vertex of the aspherical surface on the optic axis).

For convenience, the aspherical surface of each lens adopts the aspherical surface defined in the above equation (1). However, the present invention is not limited to the aspherical surface defined by the polynomial expressed by the equation (1).

Table 3 shows free-form surface data in the camera optical lens 10 according to the Embodiment 1 of the present invention.

TABLE 3

| | Free-form surface coefficient | | | | | | | |
|---|---|---|---|---|---|---|---|---|
| | k | X⁴Y⁰ | X²Y² | X⁰Y⁴ | X⁶Y⁰ | X⁴Y² | X²Y⁴ | X⁰Y⁶ |
| R9 | −9.4214E + 00 | −3.8232E − 01 | −7.6135E − 01 | −3.8374E − 01 | 2.2084E − 01 | 6.6003E − 01 | 6.6137E − 01 | 2.2196E − 01 |
| R10 | −3.9146E + 00 | −1.9137E − 01 | −3.7585E − 01 | −1.9366E − 01 | 1.4129E − 01 | 4.2169E − 01 | 4.2120E − 01 | 1.4214E − 01 |
| | X⁴Y⁶ | X²Y⁸ | X⁰ Y¹⁰ | X¹²Y⁰ | X¹⁰Y² | X⁸Y⁴ | X⁶Y⁶ | X⁴Y⁸ |
| R9 | 4.2153E − 01 | 2.1077E − 01 | 4.1978E − 02 | −1.8515E − 02 | −1.1109E − 01 | −2.7770E − 01 | −3.7026E − 01 | −2.7764E − 01 |
| R10 | 2.7427E − 01 | 1.3712E − 01 | 2.7432E − 02 | −7.0293E − 03 | −4.2373E − 02 | −1.0593E − 01 | −1.4121E − 01 | −1.0593E − 01 |
| | X²Y¹² | X⁰Y¹⁴ | X¹⁶Y⁰ | X¹⁴Y² | X¹²Y⁴ | X¹⁰Y⁶ | X⁸Y⁸ | X⁶Y¹⁰ |
| R9 | 3.6717E − 02 | 5.2519E − 03 | −8.6826E − 04 | −6.9507E − 03 | −2.4321E − 02 | −4.8639E − 02 | −6.0801E − 02 | −4.8651E − 02 |
| R10 | 8.5600E − 03 | 1.2231E − 03 | −1.3498E − 04 | −1.0799E − 03 | −3.7799E − 03 | −7.5602E − 03 | −9.4510E − 03 | −7.5592E − 03 |
| | X⁸Y¹⁰ | X⁶Y¹² | X⁴Y¹⁴ | X²Y¹⁶ | X⁰Y¹⁸ | X²⁰Y⁰ | X¹⁸Y² | X¹⁶Y⁴ |
| R9 | 9.6775E − 03 | 6.4468E − 03 | 2.7606E − 03 | 6.8966E − 04 | 7.7064E − 05 | −2.8292E − 06 | −2.8071E − 05 | −1.2685E − 04 |
| R10 | 1.0742E − 03 | 7.1614E − 04 | 3.0690E − 04 | 7.6790E − 05 | 8.5223E − 06 | −2.3273E − 07 | −2.3342E − 06 | −1.0495E − 05 |
| | X⁸Y⁰ | X⁶Y² | X⁴Y⁴ | X²Y⁶ | X⁰Y⁸ | X¹⁰Y⁰ | X⁸Y² | X⁶Y⁴ |
| R9 | −8.7985E − 02 | −3.5098E − 01 | −5.2812E − 01 | −3.5167E − 01 | −8.7965E − 02 | 4.2108E − 02 | 2.1080E − 01 | 4.2148E − 01 |
| R10 | −7.3898E − 02 | −2.9594E − 01 | −4.4428E − 01 | −2.9554E − 01 | −7.4193E − 02 | 2.7312E − 02 | 1.3719E − 01 | 2.7437E − 01 |
| | X²Y¹⁰ | X⁰Y¹² | X¹⁴Y⁰ | X¹²Y² | X¹⁰Y⁴ | X⁸Y⁶ | X⁶Y⁸ | X⁴Y¹⁰ |
| R9 | −1.1104E − 01 | −1.8504E − 02 | 5.2534E − 03 | 3.6758E − 02 | 1.1029E − 01 | 1.8383E − 01 | 1.8382E − 01 | 1.1031E − 01 |
| R10 | −4.2367E − 02 | −7.0629E − 03 | 1.2195E − 03 | 8.5604E − 03 | 2.5683E − 02 | 4.2800E − 02 | 4.2806E − 02 | 2.5682E − 02 |
| | X⁴Y¹² | X²Y¹⁴ | X⁰Y¹⁶ | X¹⁸Y⁰ | X¹⁶Y² | X¹⁴Y⁴ | X¹²Y⁶ | X¹⁰Y⁸ |
| R9 | −2.4317E − 02 | −6.9319E − 03 | −8.6787E − 04 | 7.6824E − 05 | 6.9102E − 04 | 2.7651E − 03 | 6.4521E − 03 | 9.6772E − 03 |
| R10 | −3.7803E − 03 | −1.0795E − 03 | −1.3501E − 04 | 8.5352E − 06 | 7.6739E − 05 | 3.0693E − 04 | 7.1620E − 04 | 1.0743E − 03 |
| | X¹⁴Y⁶ | X¹²Y⁸ | X¹⁰Y¹⁰ | X⁸Y¹² | X⁶Y¹⁴ | X⁴Y¹⁶ | X²Y¹⁸ | X⁰Y²⁰ |
| R9 | −3.3839E − 04 | −5.9254E − 04 | −7.1106E − 04 | −5.9190E − 04 | −3.3616E − 04 | −1.2691E − 04 | −2.8226E − 05 | −2.8703E − 06 |
| R10 | −2.8014E − 05 | −4.8947E − 05 | −5.8701E − 05 | −4.9035E − 05 | −2.8010E − 05 | −1.0458E − 05 | −2.3641E − 06 | −2.3243E − 07 |

$$Z = \frac{c {r}^{2}}{1 + \sqrt{1 - ( 1 + k ) {c}^{2} {r}^{2}}} + {\sum }_{i = 1}^{N} {B}_{i} {E}_{i} ( x , y ) \qquad ( 2 )$$

Herein in the equation (2), k represents a cone coefficient, Bi represents an aspherical coefficient, c represents a curvature at the center of a optical surface, r represents a vertical distance between a point on the free-form surface and an optic axis, x represents an x-direction component of r, y represents a y-direction component of r, z represents an aspherical depth (a vertical distance between a point on the aspherical surface that is distanced from the optic axis by r and a tangent plane tangent to a vertex of the aspherical surface on the optic axis).

For convenience, each free-form surface adopts the surface type defined by the extended polynomial shown in the above equation (2). However, the present invention is not limited to the free-form surface defined by the polynomial expressed by the equation (2).

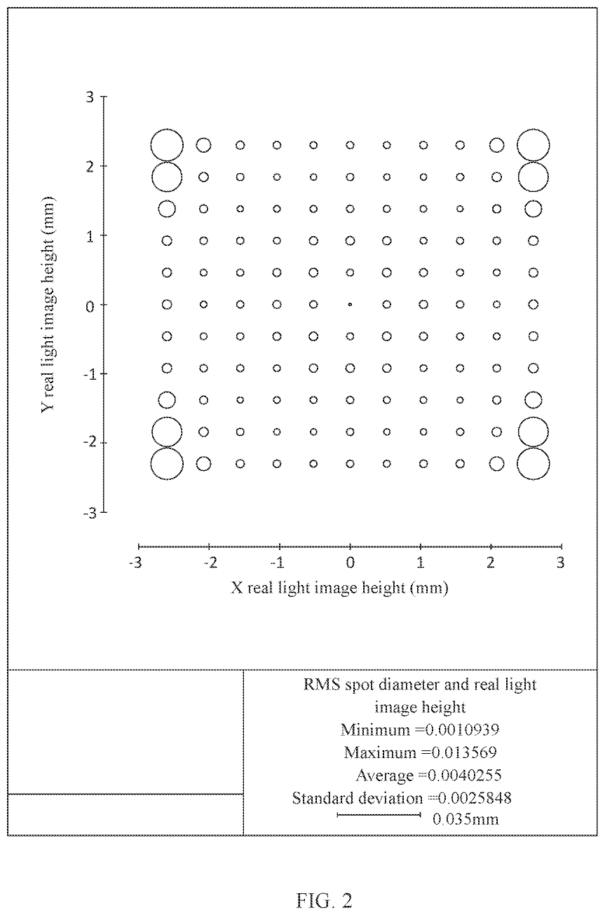

FIG. 2 shows a situation where the RMS spot diameter of the camera optical lens 10 according to the Embodiment 1 is within a first quadrant. According to FIG. 2, it can be seen that the camera optical lens 10 according to the Embodiment 1 can achieve good imaging quality.

Values corresponding to various numerical values and the parameters already specified in the conditions for each of the Embodiment 1 are shown in Table 16.

As shown in Table 16, the Embodiment 1 satisfies the respective conditions.

In this embodiment, an entrance pupil diameter ENPD of the camera optical lens is 1.707 mm, the full field of view image height IH (in a diagonal direction) is 6.940 mm, the image height in an x direction is 5.200 mm, the image height in a y direction is 4.600 mm, and the imaging effect is the best in this rectangular area; the FOV in a diagonal direction is 87.03°, the FOV in the x direction is 71.24°, and the FOV in the y direction is 65.17°. The camera optical lens 10 satisfies the design requirements of a wide angle, ultra-thinness and a large aperture, its on-axis and off-axis color aberrations are sufficiently corrected, and the camera optical lens has excellent optical characteristics.

### Embodiment 2

Embodiment 2 is basically the same as Embodiment 1, the symbols in Embodiment 2 are defined the same as those in Embodiment 1, and only the difference from Embodiment 1 will be described in the following.

Table 4 and Table 5 show design data of the camera optical lens 20 according to the Embodiment 2 of the present invention. Herein, the object side surface and the image side surface of the first lens L1 are free-form surfaces.

TABLE 4

| | R | d | | nd | | vd | |
|---|---|---|---|---|---|---|---|
| S1 | ∞ | d0 = | −0.240 | | | | |
| R1 | 1.523 | d1 = | 0.467 | nd1 | 1.5444 | v1 | 55.82 |
| R2 | 7.329 | d2 = | 0.205 | | | | |
| R3 | −4.456 | d3 = | 0.211 | nd2 | 1.6700 | v2 | 19.39 |
| R4 | −39.796 | d4 = | 0.192 | | | | |
| R5 | 13.725 | d5 = | 0.314 | nd3 | 1.5444 | v3 | 55.82 |
| R6 | −19.076 | d6 = | 0.636 | | | | |
| R7 | −8.510 | d7 = | 0.546 | nd4 | 1.5444 | v4 | 55.82 |
| R8 | −1.656 | d8 = | 0.336 | | | | |
| R9 | 2.895 | d9 = | 0.482 | nd5 | 1.5444 | v5 | 55.82 |
| R10 | 0.949 | d10 = | 0.390 | | | | |
| R11 | ∞ | d11 = | 0.210 | ndg | 1.5168 | vg | 64.17 |
| R12 | ∞ | d12 = | 0.360 | | | | |

Table 5 shows aspherical data of the respective lenses in the camera optical lens 20 according to the Embodiment 2 of the present invention.

TABLE 5

| | Cone coefficient | Aspherical coefficient | | | | |
|---|---|---|---|---|---|---|
| | k | A4 | A6 | A8 | A10 | A12 |
| R3 | −1.5442E + 02 | −4.0236E − 02 | 1.3372E − 01 | 1.3228E + 00 | −1.0330E + 01 | 3.7406E + 01 |
| R4 | 2.0009E + 03 | 1.6028E − 01 | −2.8659E − 01 | 2.9464E + 00 | −1.7499E + 01 | 6.0669E + 01 |
| R5 | 3.5869E + 01 | −1.8823E − 01 | 6.7502E − 01 | −5.3550E + 00 | 2.6887E + 01 | −8.9162E + 01 |
| R6 | 3.2988E + 02 | −1.3288E − 01 | 2.7755E − 01 | −1.6958E + 00 | 6.0212E + 00 | −1.4445E + 01 |
| R7 | 2.1840E + 01 | 1.7666E − 02 | −2.0584E − 02 | −2.0190E − 01 | 4.7431E − 01 | −5.2456E − 01 |
| R8 | −2.6759E − 01 | 2.5060E − 02 | −1.1537E − 03 | −6.7987E − 02 | 1.1629E − 01 | −7.3126E − 02 |
| R9 | −2.5719E + 01 | −3.8091E − 01 | 2.2130E − 01 | −8.7910E − 02 | 4.2127E − 02 | −1.8516E − 02 |
| R10 | −4.3230E + 00 | −1.9022E − 01 | 1.4009E − 01 | −7.3922E − 02 | 2.7443E − 02 | −7.0620E − 03 |
| | k | A14 | A16 | A18 | A20 | |
| R3 | −1.5442E + 02 | −8.1129E + 01 | 1.0554E + 02 | −7.5212E + 01 | 2.2342E + 01 | |
| R4 | 2.0009E + 03 | −1.2679E + 02 | 1.5699E + 02 | −1.0567E + 02 | 2.9815E + 01 | |
| R5 | 3.5869E + 01 | 1.8693E + 02 | −2.3707E + 02 | 1.6487E + 02 | −4.7797E + 01 | |
| R6 | 3.2988E + 02 | 2.2404E + 01 | −2.1286E + 01 | 1.1124E + 01 | −2.3976E + 00 | |
| R7 | 2.1840E + 01 | 3.2915E − 01 | −1.2007E − 01 | 2.4084E − 02 | −2.0901E − 03 | |
| R8 | −2.6759E − 01 | 2.3858E − 02 | −4.3471E − 03 | 4.2737E − 04 | −1.8498E − 05 | |
| R9 | −2.5719E + 01 | 5.2522E − 03 | −8.6850E − 04 | 7.6825E − 05 | −2.8210E − 06 | |
| R10 | −4.3230E + 00 | 1.2228E − 03 | −1.3503E − 04 | 8.5255E − 06 | −2.3241E − 07 | |

Table 6 shows the free-form surface data in the camera optical lens 20 according to the Embodiment 2 of the present invention.

TABLE 6

| | Free-form surface coefficient | | | | | | | |
|---|---|---|---|---|---|---|---|---|
| | k | X⁴Y⁰ | X²Y² | X⁰Y⁴ | X⁶Y⁰ | X⁴Y² | X²Y⁴ | X⁰Y⁶ |
| R1 | 8.1606E − 02 | −6.6724E − 03 | −1.3348E − 02 | −6.6838E − 03 | 1.2374E − 01 | 3.7084E − 01 | 3.7213E − 01 | 1.2375E − 01 |
| R2 | 1.8097E + 01 | 5.3785E − 03 | 1.1103E − 02 | 5.3960E − 03 | −1.7115E − 01 | −5.1329E − 01 | −5.1270E − 01 | −1.7113E − 01 |
| | X⁴Y⁶ | X²Y⁸ | X⁰Y¹⁰ | X¹²Y⁰ | X¹⁰Y² | X⁸Y⁴ | X⁶Y⁶ | X⁴Y⁸ |
| R1 | 4.3206E + 01 | 2.1600E + 01 | 4.3206E + 00 | −1.2314E + 01 | −7.3888E + 02 | −1.8472E + 02 | −2.4628E + 02 | −1.8471E + 02 |
| R2 | −1.1422E + 02 | −5.7116E + 01 | −1.1422E + 01 | 4.1629E + 01 | 2.4976E + 02 | 6.2441E + 02 | 8.3256E + 02 | 6.2443E + 02 |
| | X²Y¹² | X⁰Y¹⁴ | X¹⁶Y⁰ | X¹⁴Y² | X¹²Y⁴ | X¹⁰Y⁶ | X⁸Y⁸ | X⁶Y¹⁰ |
| R1 | 1.4991E + 02 | 2.1416E + 01 | −2.2322E + 01 | −1.7858E + 02 | −6.2502E + 02 | −1.2500E + 03 | −1.5625E + 03 | −1.2501E + 03 |
| R2 | −6.4577E + 02 | −9.2251E + 01 | 1.2072E + 02 | 9.6577E + 02 | 3.3803E + 03 | 6.7603E + 03 | 8.4505E + 03 | 6.7603E + 03 |
| | X⁸Y¹⁰ | X⁶Y¹² | X⁴Y¹⁴ | X²Y¹⁶ | X⁰Y¹⁸ | X²⁰Y⁰ | X¹⁸Y² | X¹⁶Y⁴ |
| R1 | 1.6225E + 03 | 1.0816E + 03 | 4.6362E + 02 | 1.1588E + 02 | 1.2877E + 01 | −3.2009E + 00 | −3.2029E + 01 | −1.4386E + 02 |
| R2 | −1.0776E + 04 | −7.1846E + 03 | −3.0786E + 03 | −7.6975E + 02 | −8.5523E + 01 | 2.5164E + 01 | 2.5152E + 02 | 1.1335E + 03 |
| | X⁸Y⁰ | X⁶Y² | X⁴Y⁴ | X²Y⁶ | X⁰Y⁸ | X¹⁰Y⁰ | X⁸Y² | X⁶Y⁴ |
| R1 | −9.1333E − 01 | −3.6546E + 00 | −5.4792E + 00 | −3.6544E + 00 | −9.1330E − 01 | 4.3205E + 00 | 2.1600E + 01 | 4.3203E + 01 |
| R2 | 1.8692E + 00 | 7.4740E + 00 | 1.1216E + 01 | 7.4762E + 00 | 1.8692E + 00 | −1.1422E + 01 | −5.7118E + 01 | −1.1423E + 02 |
| | X²Y¹⁰ | X⁰Y¹² | X¹⁴Y⁰ | X¹²Y² | X¹⁰Y⁴ | X⁸Y⁶ | X⁶Y⁸ | X⁴Y¹⁰ |
| R1 | −7.3888E + 01 | −1.2314E + 01 | 2.1416E + 01 | 1.4991E + 02 | 4.4973E + 02 | 7.4956E + 02 | 7.4956E + 02 | 4.4973E + 02 |
| R2 | 2.4976E + 02 | 4.1629E + 01 | −9.2251E + 01 | −6.4576E + 02 | −1.9373E + 03 | −3.2288E + 03 | −3.2288E + 03 | −1.9373E + 03 |
| | X⁴Y¹² | X²Y¹⁴ | X⁰Y¹⁶ | X¹⁸Y⁰ | X¹⁶Y² | X¹⁴Y⁴ | X¹²Y⁶ | X¹⁰Y⁸ |
| R1 | −6.2501E + 02 | −1.7858E + 02 | −2.2322E + 01 | 1.2877E + 01 | 1.1588E + 02 | 4.6360E + 02 | 1.0816E + 03 | 1.6225E + 03 |
| R2 | 3.3802E + 03 | 9.6576E + 02 | 1.2072E + 02 | −8.5523E + 01 | −7.6974E + 02 | −3.0784E + 03 | −7.1845E + 03 | −1.0776E + 04 |
| | X¹⁴Y⁶ | X¹²Y⁸ | X¹⁰Y¹⁰ | X⁸Y¹² | X⁶Y¹⁴ | X⁴Y¹⁶ | X²Y¹⁸ | X⁰Y²⁰ |
| R1 | −3.8413E + 02 | −6.7235E + 02 | −8.0646E + 02 | −6.7238E + 02 | −3.8432E + 02 | −1.4378E + 02 | −3.2031E + 01 | −3.2014E + 00 |
| R2 | 3.0166E + 03 | 5.2863E + 03 | 6.3444E + 03 | 5.2843E + 03 | 3.0174E + 03 | 1.1338E + 03 | 2.5153E + 02 | 2.5163E + 01 |

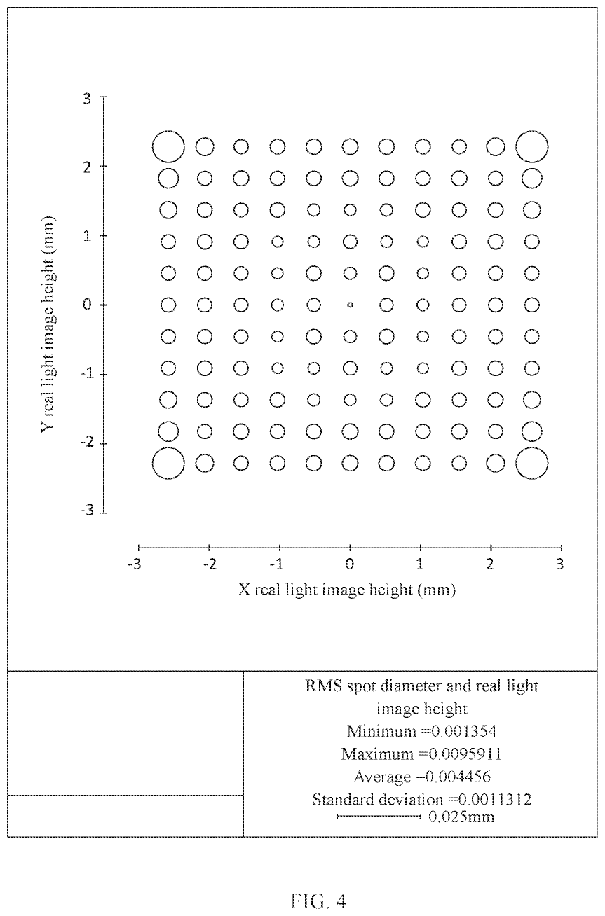

FIG. 4 shows a situation where the RMS spot diameter of the camera optical lens 20 according to Embodiment 2 is within a first quadrant. According to FIG. 4, it can be seen that the camera optical lens 20 according to Embodiment 2 can achieve good imaging quality.

As shown in Table 16, Embodiment 2 satisfies respective conditions.

In this embodiment, an entrance pupil diameter ENPD of the camera optical lens is 1.720 mm, the full field of view image height IH (in a diagonal direction) is 6.940 mm, the image height in an x direction is 5.200 mm, the image height in a y direction is 4.600 mm, and the imaging effect is the best in this rectangular area; the FOV in a diagonal direction is 88.27°, the FOV in the x direction is 72.46°, and the FOV in the y direction is 65.96°. The camera optical lens 20 satisfies the design requirements of a wide angle, ultra-thinness and a large aperture, and its on-axis and off-axis color aberrations are sufficiently corrected, and the camera optical lens has excellent optical characteristics.

### Embodiment 3

Embodiment 3 is basically the same as Embodiment 1, and the symbols in the Embodiment 3 are defined the same as those in Embodiment 1, and only the difference from Embodiment 1 will be described in the following.

Table 7 and Table 8 show design data of the camera optical lens 30 according to Embodiment 3 of the present invention. Herein, the object side surface and the image side surface of the first lens L1 are free-form surfaces.

TABLE 7

| | R | d | | nd | | vd | |
|---|---|---|---|---|---|---|---|
| S1 | ∞ | d0 = | −0.251 | | | | |
| R1 | 1.524 | d1 = | 0.454 | nd1 | 1.5444 | v1 | 55.82 |
| R2 | 7.250 | d2 = | 0.211 | | | | |
| R3 | −4.445 | d3 = | 0.212 | nd2 | 1.6700 | v2 | 19.39 |
| R4 | −39.732 | d4 = | 0.194 | | | | |
| R5 | 13.750 | d5 = | 0.313 | nd3 | 1.5444 | v3 | 55.82 |
| R6 | −19.098 | d6 = | 0.645 | | | | |
| R7 | −8.511 | d7 = | 0.552 | nd4 | 1.5444 | v4 | 55.82 |
| R8 | −1.660 | d8 = | 0.336 | | | | |
| R9 | 2.941 | d9 = | 0.481 | nd5 | 1.5444 | v5 | 55.82 |
| R10 | 0.952 | d10 = | 0.390 | | | | |
| R11 | ∞ | d11 = | 0.210 | ndg | 1.5168 | vg | 64.17 |
| R12 | ∞ | d12 = | 0.379 | | | | |

Table 8 shows aspherical data of the respective lenses in the camera optical lens 30 according to the Embodiment 3 of the present invention.

TABLE 8

| | Cone coefficient | Aspherical coefficient | | | | |
|---|---|---|---|---|---|---|
| | k | A4 | A6 | A8 | A10 | A12 |
| R3 | −1.5140E + 02 | −3.9745E − 02 | 1.3460E − 01 | 1.3239E + 00 | −1.0329E + 01 | 3.7405E + 01 |
| R4 | 1.9971E + 03 | 1.6007E − 01 | −2.8684E − 01 | 2.9461E + 00 | −1.7499E + 01 | 6.0669E + 01 |
| R5 | 3.4844E + 01 | −1.8818E − 01 | 6.7446E − 01 | −5.3554E + 00 | 2.6887E + 01 | −8.9162E + 01 |
| R6 | 3.2901E + 02 | −1.3363E − 01 | 2.7706E − 01 | −1.6959E + 00 | 6.0213E + 00 | −1.4445E + 01 |
| R7 | 2.2378E + 01 | 1.6208E − 02 | −1.9440E − 02 | −2.0204E − 01 | 4.7427E − 01 | −5.2457E − 01 |
| R8 | −2.6852E − 01 | 2.4746E − 02 | −1.2985E − 03 | −6.7998E − 02 | 1.1629E − 01 | −7.3127E − 02 |
| R9 | −2.4885E + 01 | −3.8105E − 01 | 2.2127E − 01 | −8.7911E − 02 | 4.2127E − 02 | −1.8516E − 02 |
| R10 | −4.3440E + 00 | −1.9010E − 01 | 1.4009E − 01 | −7.3926E − 02 | 2.7443E − 02 | −7.0620E − 03 |
| | k | A14 | A16 | A18 | A20 | |
| R3 | −1.5140E + 02 | −8.1133E + 01 | 1.0553E + 02 | −7.5210E + 01 | 2.2363E + 01 | |
| R4 | 1.9971E + 03 | −1.2679E + 02 | 1.5699E + 02 | −1.0566E + 02 | 2.9818E + 01 | |
| R5 | 3.4844E + 01 | 1.8693E + 02 | −2.3707E + 02 | 1.6487E + 02 | −4.7795E + 01 | |
| R6 | 3.2901E + 02 | 2.2404E + 01 | −2.1286E + 01 | 1.1124E + 01 | −2.3977E + 00 | |
| R7 | 2.2378E + 01 | 3.2915E − 01 | −1.2007E − 01 | 2.4084E − 02 | −2.0901E − 03 | |
| R8 | −2.6852E − 01 | 2.3858E − 02 | −4.3471E − 03 | 4.2739E − 04 | −1.8483E − 05 | |
| R9 | −2.4885E + 01 | 5.2522E − 03 | −8.6850E − 04 | 7.6825E − 05 | −2.8210E − 06 | |
| R10 | −4.3440E + 00 | 1.2228E − 03 | −1.3503E − 04 | 8.5255E − 06 | −2.3241E − 07 | |

Table 9 shows free-form surface data in the camera optical lens 30 according to the Embodiment 3 of the present invention.

TABLE 9

| | Free-form surface coefficient | | | | | | | |
|---|---|---|---|---|---|---|---|---|
| | k | X⁴Y⁰ | X²Y² | X⁰Y⁴ | X⁶Y⁰ | X⁴Y² | X²Y⁴ | X⁰Y⁶ |
| R1 | 8.5774E − 02 | −6.0238E − 03 | −1.2768E − 02 | −6.1088E − 03 | 1.2391E − 01 | 3.7327E − 01 | 3.7617E − 01 | 1.2400E − 01 |
| R2 | 1.9042E + 01 | 5.6304E − 03 | 1.2190E − 02 | 5.7057E − 03 | −1.6982E − 01 | −5.0937E − 01 | −5.0756E − 01 | −1.7009E − 01 |
| | X⁴Y⁶ | X²Y⁸ | X⁴Y⁶ | X¹²Y⁰ | X¹⁰Y² | X⁸Y⁴ | X⁶Y⁶ | X⁴Y⁸ |
| R1 | 4.3211E + 01 | 2.1596E + 01 | 4.3210E + 00 | −1.2313E + 01 | −7.3882E + 01 | −1.8472E + 02 | −2.4629E + 02 | −1.8471E + 02 |
| R2 | −1.1420E + 02 | −5.7112E + 01 | −1.1419E + 01 | 4.1629E + 01 | 2.4978E + 02 | 6.2441E + 02 | 8.3256E + 02 | 6.2445E + 02 |
| | X²Y¹² | X⁰Y¹⁴ | X¹⁶Y⁰ | X¹⁴Y² | X¹²Y⁴ | X¹⁰Y⁶ | X⁸Y⁸ | X⁶Y¹⁰ |
| R1 | 1.4992E + 02 | 2.1418E + 01 | −2.2320E + 01 | −1.7855E + 02 | −6.2499E + 02 | −1.2501E + 03 | −1.5624E + 03 | −1.2501E + 03 |
| R2 | −6.4578E + 02 | −9.2254E + 01 | 1.2072E + 02 | 9.6572E + 02 | 3.3803E + 03 | 6.7599E + 03 | 8.4505E + 03 | 6.7600E + 03 |
| | X⁸Y¹⁰ | X⁶Y¹² | X⁴Y¹⁴ | X²Y¹⁶ | X⁰Y¹⁸ | X²⁰Y⁰ | X¹⁸Y² | X¹⁶Y⁴ |
| R1 | 1.6228E + 03 | 1.0814E + 03 | 4.6371E + 02 | 1.1590E + 02 | 1.2878E + 01 | −3.2027E + 00 | −3.2105E + 01 | −1.4366E + 02 |
| R2 | −1.0775E + 04 | −7.1852E + 03 | −3.0785E + 03 | −7.6976E + 02 | −8.5522E + 01 | 2.5177E + 01 | 2.5172E + 02 | 1.1344E + 03 |
| | X⁸Y⁰ | X⁶Y² | X⁴Y⁴ | X²Y⁶ | X⁰Y⁸ | X¹⁰Y⁰ | X⁸Y² | X⁶Y⁴ |
| R1 | −9.1334E − 01 | −3.6554E + 00 | −5.4741E + 00 | −3.6562E + 00 | −9.1320E − 00 | 4.3207E + 00 | 2.1600E + 01 | 4.3202E + 01 |
| R2 | 1.8715E + 00 | 7.4789E + 00 | 1.1230E + 01 | 7.4818E + 00 | 1.8717E + 00 | −1.1420E + 01 | −5.7105E + 01 | −1.1422E + 02 |
| | X²Y¹⁰ | X⁰Y¹² | X¹⁴Y⁰ | X¹²Y² | X¹⁰Y⁴ | X⁸Y⁶ | X⁶Y⁸ | X⁴Y¹⁰ |
| R1 | −7.3888E + 01 | −1.2313E + 01 | 2.1418E + 01 | 1.4993E + 02 | 4.4974E + 02 | 7.4956E + 02 | 7.4958E + 02 | 4.4975E + 02 |
| R2 | 2.4976E + 02 | 4.1629E + 01 | −9.2253E + 01 | −6.4577E + 02 | −1.9373E + 03 | −3.2290E + 03 | −3.2289E + 03 | −1.9373E + 03 |
| | X⁴Y¹² | X²Y¹⁴ | X⁰Y¹⁶ | X¹⁸Y⁰ | X¹⁶Y² | X¹⁴Y⁴ | X¹²Y⁶ | X¹⁰Y⁸ |
| R1 | −6.2496E + 02 | −1.7856E + 02 | −2.2321E + 01 | 1.2878E + 01 | 1.1589E + 02 | 4.6367E + 02 | 1.0815E + 03 | 1.6228E + 03 |
| R2 | 3.3802E + 03 | 9.6574E + 02 | 1.2072E + 02 | −8.5521E + 01 | −7.6978E + 02 | −3.0783E + 03 | −7.1853E + 03 | −1.0775E + 04 |
| | X¹⁴Y⁶ | X¹²Y⁸ | X¹⁰Y¹⁰ | X⁸Y¹² | X⁶Y¹⁴ | X⁴Y¹⁶ | X²Y¹⁸ | X⁰Y²⁰ |
| R1 | −3.8482E + 02 | −6.7206E + 02 | −8.0475E + 02 | −6.7231E + 02 | −3.8504E + 02 | −1.4369E + 02 | −3.2075E + 01 | −3.2027E + 00 |
| R2 | 3.0165E + 03 | 5.2923E + 03 | 6.3496E + 03 | 5.2890E + 03 | 3.0172E + 03 | 1.1346E + 03 | 2.5172E + 02 | 2.5175E + 01 |

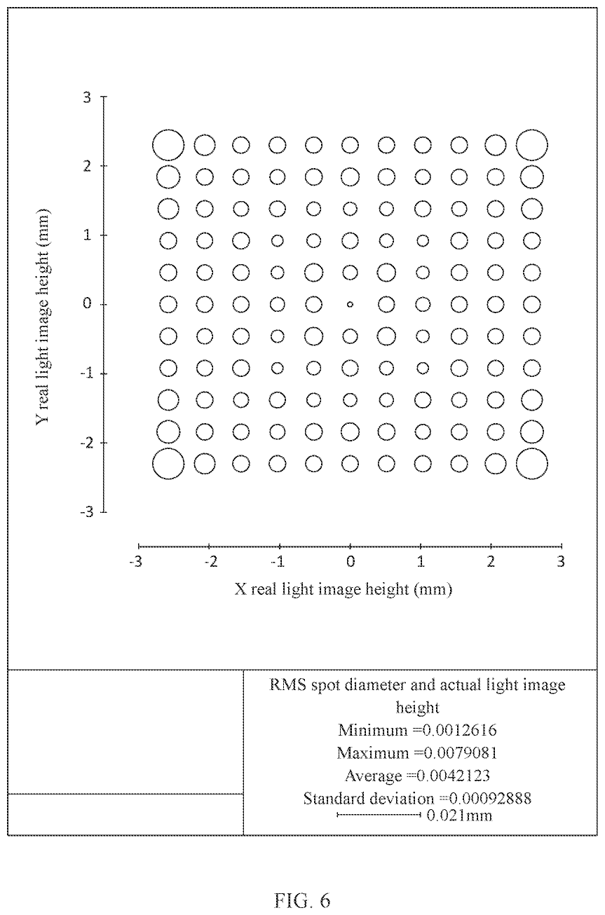

FIG. 6 shows a situation where the RMS spot diameter of the camera optical lens 30 according to the Embodiment 3 is within a first quadrant. According to FIG. 6, it can be seen that the camera optical lens 30 according to the Embodiment 3 can achieve good imaging quality.

The numerical values corresponding to the respective conditions in this embodiment according to the above-mentioned conditions are listed in Table 16. It can be seen that the imaging optical system according to this embodiment satisfies the above-mentioned conditions.

In this embodiment, an entrance pupil diameter ENPD of the camera optical lens is 1.741 mm, the full field of view image height IH (in a diagonal direction) is 6.940 mm, the image height in an x direction is 5.200 mm, the image height in a y direction is 4.600 mm, and the imaging effect is the best in this rectangular area; the FOV in a diagonal direction is 88.09°, the FOV in the x direction is 71.99°, and the FOV in the y direction is 65.46°. The camera optical lens 30 satisfies the design requirements of a wide angle, ultra-thinness and a large aperture, and its on-axis and off-axis color aberration is sufficiently corrected, and the camera optical lens has excellent optical characteristics.

### Embodiment 4

The Embodiment 4 is basically the same as the Embodiment 1, and the symbols in the Embodiment 4 are the same as those in the Embodiment 1, and only the difference from Embodiment 1 will be described in the following.

In this embodiment, the image side surface of the third lens L3 is a concave surface at a paraxial position.

Table 10 and Table 11 show design data of the camera optical lens 40 according to the Embodiment 4 of the present invention. Herein, the object side surface and the image side surface of the fourth lens L4 are free-form surfaces.

TABLE 10

| | R | d | | nd | | vd | |
|---|---|---|---|---|---|---|---|
| S1 | ∞ | d0 = | −0.243 | | | | |
| R1 | 1.533 | d1 = | 0.666 | nd1 | 1.5440 | v1 | 56.40 |
| R2 | 5.175 | d2 = | 0.499 | | | | |
| R3 | −4.737 | d3 = | 0.220 | nd2 | 1.6800 | v2 | 18.40 |
| R4 | −99.346 | d4 = | 0.070 | | | | |
| R5 | 3.815 | d5 = | 0.749 | nd3 | 1.5440 | v3 | 56.40 |
| R6 | 13.461 | d6 = | 0.219 | | | | |
| R7 | −43.127 | d7 = | 0.596 | nd4 | 1.6800 | v4 | 18.40 |
| R8 | −7.260 | d8 = | 0.070 | | | | |
| R9 | 2.694 | d9 = | 0.761 | nd5 | 1.6800 | v5 | 18.40 |
| R10 | 1.446 | d10 = | 0.300 | | | | |
| R11 | ∞ | d11 = | 0.210 | ndg | 1.5168 | vg | 64.17 |
| R12 | ∞ | d12 = | 0.408 | | | | |

Table 11 shows aspherical data of the respective lenses in the camera optical lens 40 according to the Embodiment 4 of the present invention.

TABLE 11

| | Cone coefficient | Aspherical coefficient | | | | |
|---|---|---|---|---|---|---|
| | k | A4 | A6 | A8 | A10 | A12 |
| R1 | −1.2090E − 01 | 5.1479E − 03 | −3.0010E − 03 | 1.1041E − 02 | −1.6983E − 02 | 0.0000E + 00 |
| R2 | 1.0000E + 01 | −1.6195E − 02 | −5.0674E − 02 | 1.1671E − 01 | −3.5107E − 01 | 4.2465E − 01 |
| R3 | 2.0810E + 01 | −5.4735E − 02 | −1.6616E − 01 | 5.1970E − 01 | −1.0694E + 00 | 1.2625E + 00 |
| R4 | −1.0000E + 01 | −8.1094E − 02 | −1.6390E − 01 | 4.5194E − 01 | −6.1742E − 01 | 5.2106E − 01 |
| R5 | −3.2054E − 01 | −5.8848E − 02 | −6.3190E − 02 | 1.4674E − 01 | −1.7067E − 01 | 9.8100E − 02 |
| R6 | −9.1342E + 00 | 6.2800E − 02 | −1.8999E − 01 | 2.0184E − 01 | −1.4788E − 01 | 6.5396E − 02 |
| R9 | −2.8383E + 00 | −1.2967E − 01 | −2.3981E − 02 | 5.1693E − 02 | −1.6589E − 02 | −1.0017E − 03 |
| R10 | −5.1211E + 00 | −9.7421E − 02 | 4.1830E − 02 | −1.7814E − 02 | 6.6666E − 03 | −1.9743E − 03 |
| | k | A14 | A16 | A18 | A20 | |
| R1 | −1.2090E − 01 | 0.0000E + 00 | 0.0000E + 00 | 0.0000E + 00 | 0.0000E + 00 | |
| R2 | 1.0000E + 01 | −2.1501E − 01 | 0.0000E + 00 | 0.0000E + 00 | 0.0000E + 00 | |
| R3 | 2.0810E + 01 | −5.4138E − 01 | 0.0000E + 00 | 0.0000E + 00 | 0.0000E + 00 | |
| R4 | −1.0000E + 01 | −1.5039E − 01 | 0.0000E + 00 | 0.0000E + 00 | 0.0000E + 00 | |
| R5 | −3.2054E − 01 | −2.0504E − 02 | 0.0000E + 00 | 0.0000E + 00 | 0.0000E + 00 | |
| R6 | −9.1342E + 00 | −1.7336E − 02 | 2.2302E − 03 | 0.0000E + 00 | 0.0000E + 00 | |
| R9 | −2.8383E + 00 | 1.8525E − 03 | −4.7518E − 04 | 5.3264E − 05 | −2.3116E − 06 | |
| R10 | −5.1211E + 00 | 4.2021E − 04 | −5.9013E − 05 | 4.8073E − 06 | −1.6925E − 07 | |

Table 12 shows free-form surface data in the camera optical lens 40 according to the Embodiment 4 of the present invention.

TABLE 12

| | Free-form surface coefficient | | | | | | | |
|---|---|---|---|---|---|---|---|---|
| | k | X⁴Y⁰ | X²Y² | X⁰Y⁴ | X⁶Y⁰ | X⁴Y² | X²Y⁴ | X⁰Y⁶ |
| R7 | 9.5607E + 00 | 1.9818E − 01 | 3.9593E − 01 | 1.9815E − 01 | −2.8656E − 01 | −8.5918E − 01 | −8.5964E − 01 | −2.8678E − 01 |
| R8 | 3.3047E + 00 | 1.9227E − 01 | 3.8447E − 01 | 1.9209E − 01 | −2.0360E − 01 | −6.1153E − 01 | −6.1132E − 01 | −2.0324E − 01 |
| | X⁴Y⁶ | X²Y⁸ | X⁰Y¹⁰ | X¹²Y⁰ | X1⁰Y² | X⁸Y⁴ | X⁶Y⁶ | X⁴Y⁸ |
| R7 | −6.7484E − 01 | −3.3461E − 01 | −6.8229E − 02 | 6.6763E − 03 | 3.8886E − 02 | 1.0558E − 01 | 1.3525E − 01 | 1.0134E − 01 |
| R8 | −4.9127E − 01 | −2.4584E − 01 | −4.9220E − 02 | 1.3541E − 02 | 8.1259E − 02 | 2.0315E − 01 | 2.7089E − 01 | 2.0314E − 01 |
| | X²Y¹² | X⁰Y¹⁴ | X¹⁶Y⁰ | X¹⁴Y² | X¹²Y⁴ | X¹⁰Y⁶ | X⁸Y⁸ | X⁶Y¹⁰ |
| R7 | 1.3556E − 02 | 1.8205E − 03 | 0.0000E + 00 | 0.0000E + 00 | 0.0000E + 00 | 0.0000E + 00 | 0.0000E + 00 | 0.0000E + 00 |
| R8 | −1.6050E − 02 | −2.2888E − 03 | 2.1287E − 04 | 1.6973E − 03 | 5.9388E − 03 | 1.1877E − 02 | 1.4855E − 02 | 1.1878E − 02 |
| | X⁸Y¹⁰ | X⁶Y¹² | X⁴Y¹⁴ | X²Y¹⁶ | X⁰Y¹⁸ | X²⁰Y⁰ | X¹⁸Y² | X¹⁶Y⁴ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | −1.0100E − 03 | −6.7422E − 04 | −3.0111E − 04 | −7.4112E − 05 | −9.4982E − 06 | 0.0000E + 00 | 0.0000E + 00 | 0.0000E + 00 |
| | X⁸Y⁰ | X⁶Y² | X⁴Y⁴ | X²Y⁶ | X⁰Y⁸ | X¹⁰Y⁰ | X⁸Y² | X⁶Y⁴ |
| R7 | 1.7525E − 01 | 6.9864E − 01 | 1.0509E + 00 | 6.9942E − 01 | 1.7616E − 01 | −6.7635E − 02 | −3.3547E − 01 | −6.7813E − 01 |
| R8 | 1.2035E − 01 | 4.8155E − 01 | 7.2247E − 01 | 4.8137E − 01 | 1.2029E − 01 | −4.9159E − 02 | −2.4567E − 01 | −4.9148E − 01 |
| | X²Y¹⁰ | X⁰Y¹² | X¹⁴Y⁰ | X¹²Y² | X¹⁰Y⁴ | X⁸Y⁶ | X⁶Y⁸ | X⁴Y¹⁰ |
| R7 | 3.5026E − 02 | 6.3957E − 03 | 1.5655E − 03 | 1.1139E − 02 | 3.0419E − 02 | 5.2265E − 02 | 5.3896E − 02 | 3.1444E − 02 |
| R8 | 8.1260E − 02 | 1.3534E − 02 | −2.2968E − 03 | −1.6090E − 02 | −4.8274E − 02 | −8.0429E − 02 | −8.0463E − 02 | −4.8287E − 02 |
| | X⁴Y¹² | X²Y¹⁴ | X⁰Y¹⁶ | X¹⁸Y⁰ | X¹⁶Y² | X¹⁴Y⁴ | X¹²Y⁶ | X¹⁰Y⁸ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | 5.9322E − 03 | 1.7178E − 03 | 2.1817E − 04 | −8.2485E − 06 | −7.2666E − 05 | −2.8910E − 04 | −6.7887E − 04 | −1.0182E − 03 |
| | X¹⁴Y⁶ | X¹²Y⁸ | X¹⁰Y¹⁰ | X⁸Y¹² | X⁶Y¹⁴ | X⁴Y¹⁶ | X²Y¹⁸ | X⁰Y²⁰ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |

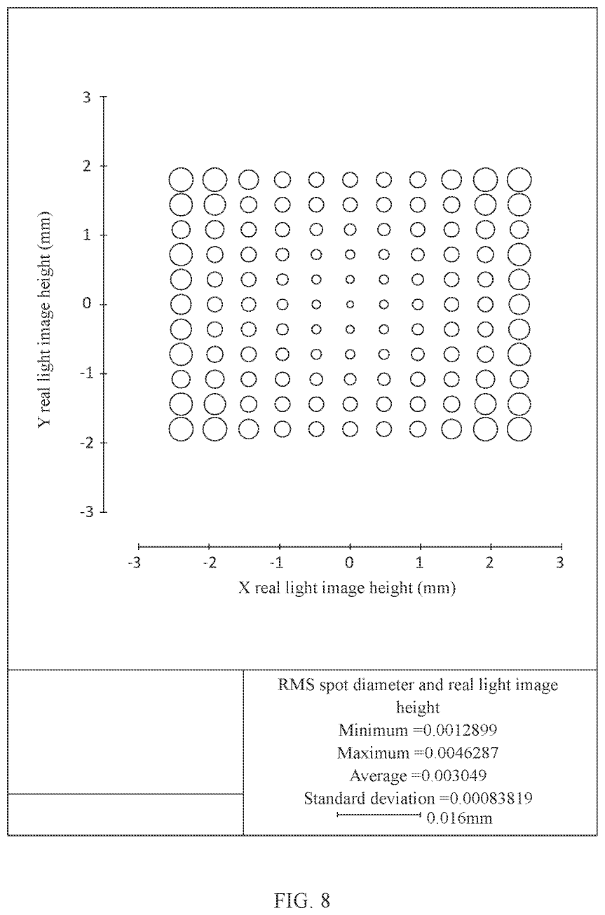

FIG. 8 shows a situation where the RMS spot diameter of the camera optical lens 40 according to the Embodiment 4 is within a first quadrant. According to FIG. 8, it can be seen that the camera optical lens 40 according to the Embodiment 4 can achieve good imaging quality.

The respective numerical values corresponding to the respective conditions in this embodiment according to the above-mentioned conditions are listed in Table 16. It can be seen that the imaging optical system according to this embodiment satisfies the above-mentioned conditions.

In this embodiment, an entrance pupil diameter ENPD of the camera optical lens is 1.696 mm, the full field of view image height IH (in a diagonal direction) is 6.000 mm, the image height in an x direction is 4.800 mm, the image height in a y direction is 3.600 mm, and the imaging effect is the best in this rectangular area; the FOV in a diagonal direction is 77.50°, the FOV in the x direction is 65.13°, and the FOV in the y direction is 50.74°. The camera optical lens 40 satisfies the design requirements of a wide angle, ultra-thinness and a large aperture, and its on-axis and off-axis color aberrations are sufficiently corrected, and the camera optical lens has excellent optical characteristics.

### Embodiment 5

The Embodiment 5 is basically the same as the Embodiment 1, the symbols in the Embodiment 5 are the same as those in the Embodiment 1, and only the difference thereof will be described in the following.

In this embodiment, the image side surface of the third lens L3 is a concave surface at a paraxial position.

Table 13 and Table 14 show design data of the camera optical lens 50 according to the Embodiment 5 of the present invention. Herein, the object side surface and the image side surface of the fourth lens L4 are free-form surfaces.

TABLE 13

| | R | d | | nd | | vd | |
|---|---|---|---|---|---|---|---|
| S1 | ∞ | d0 = | −0.244 | | | | |
| R1 | 1.529 | d1 = | 0.667 | nd1 | 1.5440 | v1 | 56.40 |
| R2 | 5.040 | d2 = | 0.496 | | | | |
| R3 | −4.665 | d3 = | 0.225 | nd2 | 1.6800 | v2 | 18.40 |
| R4 | −22.222 | d4 = | 0.083 | | | | |
| R5 | 4.361 | d5 = | 0.702 | nd3 | 1.5440 | v3 | 56.40 |
| R6 | 16.966 | d6 = | 0.232 | | | | |
| R7 | −27.027 | d7 = | 0.599 | nd4 | 1.6800 | v4 | 18.40 |
| R8 | −7.174 | d8 = | 0.070 | | | | |
| R9 | 2.740 | d9 = | 0.765 | nd5 | 1.6800 | v5 | 18.40 |
| R10 | 1.452 | d10 = | 0.300 | | | | |
| R11 | ∞ | d11 = | 0.210 | ndg | 1.5168 | vg | 64.17 |
| R12 | ∞ | d12 = | 0.405 | | | | |

Table 14 shows aspherical data of the respective lenses in the camera optical lens 50 according to the Embodiment 5 of the present invention.

TABLE 14

| | Cone coefficient | Aspherical coefficient | | | | |
|---|---|---|---|---|---|---|
| | k | A4 | A6 | A8 | A10 | A12 |
| R1 | −1.1435E − 01 | 5.2306E − 03 | −2.2181E − 03 | 9.9857E − 03 | −1.5534E − 02 | 0.0000E + 00 |
| R2 | 9.9181E + 00 | −1.5628E − 02 | −5.2602E − 02 | 1.2666E − 01 | −3.7322E − 01 | 4.4883E − 01 |
| R3 | 2.0403E + 01 | −5.5754E − 02 | −1.6552E − 01 | 5.0601E − 01 | −1.0279E + 00 | 1.2235E + 00 |
| R4 | −1.0000E + 01 | −5.7729E − 02 | −2.1152E − 01 | 5.1023E − 01 | −6.5233E − 01 | 5.3126E − 01 |
| R5 | 1.8559E + 00 | −2.8308E − 02 | −1.2188E − 01 | 2.0919E − 01 | −2.0809E − 01 | 1.0876E − 01 |
| R6 | −8.7749E + 00 | 6.5686E − 02 | −1.9043E − 01 | 1.9088E − 01 | −1.3746E − 01 | 6.0918E − 02 |
| R9 | −2.9907E + 00 | −1.3120E − 01 | −2.0684E − 02 | 4.7526E − 02 | −1.2904E − 02 | −3.2528E − 03 |
| R10 | −5.1491E + 00 | −9.9364E − 02 | 4.4881E − 02 | −2.0460E − 02 | 8.0870E − 03 | −2.4706E − 03 |
| | k | A14 | A16 | A18 | A20 | |
| R1 | −1.1435E − 01 | 0.0000E + 00 | 0.0000E + 00 | 0.0000E + 00 | 0.0000E + 00 | |
| R2 | 9.9181E + 00 | −2.2538E − 01 | 0.0000E + 00 | 0.0000E + 00 | 0.0000E + 00 | |
| R3 | 2.0403E + 01 | −5.2655E − 01 | 0.0000E + 00 | 0.0000E + 00 | 0.0000E + 00 | |
| R4 | −1.0000E + 01 | −1.5095E − 01 | 0.0000E + 00 | 0.0000E + 00 | 0.0000E + 00 | |
| R5 | 1.8559E + 00 | −2.1460E − 02 | 0.0000E + 00 | 0.0000E + 00 | 0.0000E + 00 | |
| R6 | −8.7749E + 00 | −1.6565E − 02 | 2.2599E − 03 | 0.0000E + 00 | 0.0000E + 00 | |
| R9 | −2.9907E + 00 | 2.6935E − 03 | −6.5477E − 04 | 7.3421E − 05 | −3.2369E − 06 | |
| R10 | −5.1491E + 00 | 5.3073E − 04 | −7.4157E − 05 | 5.9785E − 06 | −2.0850E − 07 | |

Table 15 shows free-form surface data in the camera optical lens 50 according to the Embodiment 5 of the present invention.

TABLE 15

| | Free-form surface coefficient | | | | | | | |
|---|---|---|---|---|---|---|---|---|
| | k | X⁴Y⁰ | X²Y² | X⁰Y⁴ | X⁶Y⁰ | X⁴Y² | X²Y⁴ | X⁰Y⁶ |
| R7 | 1.0000E + 01 | 2.0026E − 01 | 4.0048E − 01 | 2.0036E − 01 | −2.8751E − 01 | −8.6279E − 01 | −8.6304E − 01 | −2.8791E − 01 |
| R8 | 2.3642E + 00 | 1.9213E − 01 | 3.8450E − 01 | 1.9213E − 01 | −2.0366E − 01 | −6.1194E − 01 | −6.1169E − 01 | −2.0349E − 01 |
| | X⁴Y⁶ | X²Y⁸ | X⁰Y¹⁰ | X¹²Y⁰ | X¹⁰Y² | X⁸Y⁴ | X⁶Y⁶ | X⁴Y⁸ |
| R7 | −6.7963E − 01 | −3.3315E − 01 | −6.8676E − 02 | 6.7020E − 03 | 3.8348E − 02 | 1.0655E − 01 | 1.3799E − 01 | 1.0166E − 01 |
| R8 | −4.9120E − 01 | −2.4583E − 01 | −4.9207E − 02 | 1.3540E − 02 | 8.1263E − 02 | 2.0318E − 01 | 2.7087E − 01 | 2.0315E − 01 |
| | X²Y¹² | X⁰Y¹⁴ | X¹⁶Y⁰ | X¹⁴Y² | X¹²Y⁴ | X¹⁰Y⁶ | X⁸Y⁸ | X⁶Y¹⁰ |
| R7 | 1.4952E − 02 | 1.8480E − 03 | 0.0000E + 00 | 0.0000E + 00 | 0.0000E + 00 | 0.0000E + 00 | 0.0000E + 00 | 0.0000E + 00 |
| R8 | −1.6042E − 02 | −2.2926E − 03 | 2.1319E − 04 | 1.6970E − 03 | 5.9365E − 03 | 1.1880E − 02 | 1.4857E − 02 | 1.1873E − 02 |
| | X⁸Y¹⁰ | X⁶Y¹² | X⁴Y¹⁴ | X²Y¹⁶ | X⁰Y¹⁸ | X²⁰Y⁰ | X¹⁸Y² | X¹⁶Y⁴ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | −1.0099E − 03 | −6.7135E − 04 | −3.0297E − 04 | −7.4558E − 05 | −9.3880E − 06 | 0.0000E + 00 | 0.0000E + 00 | 0.0000E + 00 |
| | X⁸Y⁰ | X⁶Y² | X⁴Y⁴ | X²Y⁶ | X⁰Y⁸ | X¹⁰Y⁰ | X⁸Y² | X⁶Y⁴ |
| R7 | 1.7433E − 01 | 6.9477E − 01 | 1.0481E + 00 | 6.9461E − 01 | 1.7541E − 01 | −6.7925E − 02 | −3.3585E − 01 | −6.8354E − 01 |
| R8 | 1.2036E − 01 | 4.8147E − 01 | 7.2266E − 01 | 4.8127E − 01 | 1.2038E − 01 | −4.9164E − 02 | −2.4561E − 01 | −4.9155E − 01 |
| | X²Y¹⁰ | X⁰Y¹² | X¹⁴Y⁰ | X¹²Y² | X¹⁰Y⁴ | X⁸Y⁶ | X⁶Y⁸ | X⁴Y¹⁰ |
| R7 | 3.2924E − 02 | 6.5943E − 03 | 1.6765E − 03 | 1.2043E − 02 | 3.2657E − 02 | 5.5937E − 02 | 5.6957E − 02 | 3.4178E − 02 |
| R8 | 8.1275E − 02 | 1.3517E − 02 | −2.2962E − 03 | −1.6092E − 02 | −4.8278E − 02 | −8.0407E − 02 | −8.0474E − 02 | −4.8293E − 02 |
| | X⁴Y¹² | X²Y¹⁴ | X⁰Y¹⁶ | X¹⁸Y⁰ | X¹⁶Y² | X¹⁴Y⁴ | X¹²Y⁶ | X¹⁰Y⁸ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | 5.9279E − 03 | 1.7201E − 03 | 2.1898E − 04 | −8.3414E − 06 | −7.2701E − 05 | −2.8899E − 04 | −6.7982E − 04 | −1.0226E − 03 |
| | X¹⁴Y⁶ | X¹²Y⁸ | X¹⁰Y¹⁰ | X⁸Y¹² | X⁶Y¹⁴ | X⁴Y¹⁶ | X²Y¹⁸ | X⁰Y²⁰ |
| R7 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |
| R8 | 0.0000E + 00 | 0.0000E + 00 | 0.0000E + 00 | 0.0000E + 00 | 0.0000E + 00 | 0.0000E + 00 | 0.0000E + 00 | 0.0000E + 00 |

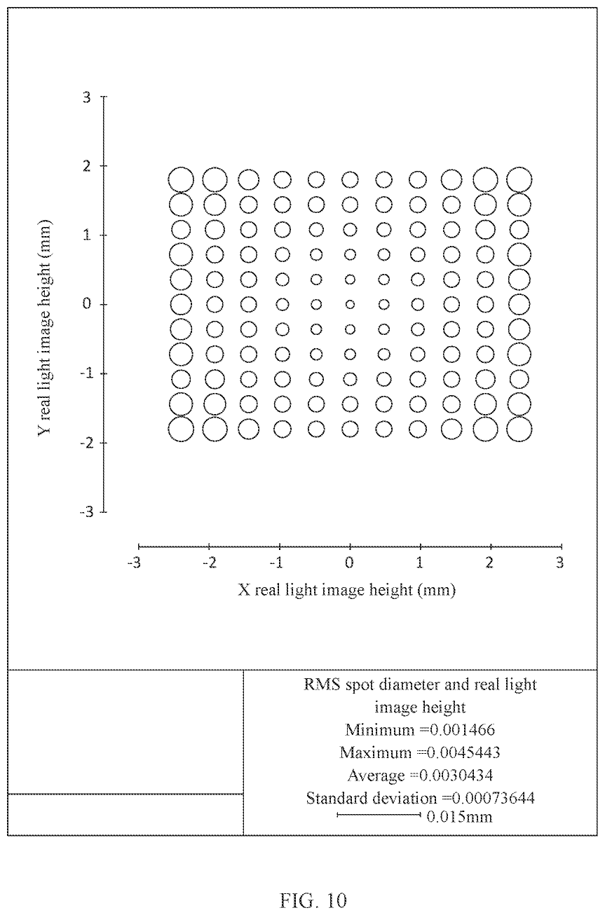

FIG. 10 shows a situation where the RMS spot diameter of the camera optical lens 50 according to the Embodiment 5 is within a first quadrant. According to FIG. 10, it can be seen that the camera optical lens 50 according to the Embodiment 5 can achieve good imaging quality.

The numerical values corresponding to the respective conditions in this embodiment according to the above-mentioned condition are listed in Table 16. It can be seen that the imaging optical system according to this embodiment satisfies the above-mentioned conditions.

In this embodiment, an entrance pupil diameter ENPD of the camera optical lens is 1.695 mm, the full field of view image height IH (in a diagonal direction) is 6.000 mm, the image height in an x direction is 4.800 mm, the image height in a y direction is 3.600 mm, and the imaging effect is the best in this rectangular area; the field of view FOV in a diagonal direction is 77.50°, the field of view in the x direction is 65.16°, and the field of view in the y direction is 50.74°. The camera optical lens 50 satisfies the design requirements of a wide angle, ultra-thinness and a large aperture, and its on-axis and off-axis color aberrations are sufficiently corrected, and the camera optical lens has excellent optical characteristics.

TABLE 16

| Parameters and | Embodiment | Embodiment | Embodiment | Embodiment | Embodiment |
|---|---|---|---|---|---|
| Conditions | 1 | 2 | 3 | 4 | 5 |
| R4 | −39.88 | −39.80 | −39.73 | −99.35 | −22.22 |
| f | 3.415 | 3.439 | 3.483 | 3.732 | 3.730 |
| f1 | 3.273 | 3.419 | 3.433 | 3.744 | 3.765 |
| f2 | −7.382 | −7.418 | −7.399 | −7.230 | -8.617 |
| f3 | 15.328 | 14.649 | 14.671 | 9.484 | 10.538 |
| f4 | 3.864 | 3.659 | 3.667 | 12.590 | 14.009 |
| f5 | −2.930 | −2.831 | −2.813 | −6.031 | −5.922 |
| FNO | 2.00 | 2.00 | 2.00 | 2.20 | 2.20 |
| TTL | 4.282 | 4.349 | 4.377 | 4.768 | 4.754 |
| IH | 6.940 | 6.940 | 6.940 | 6.000 | 6.000 |
| FOV | 87.03° | 88.27° | 88.09° | 77.50° | 77.50° |

It should be understood by those skilled in the art that the above embodiments are merely some specific embodiments of the present invention, and various changes in form and details may be made without departing from the scope of the present invention.

What is claimed is:

1. A camera optical lens, comprising, from an object side to an image side:
a first lens having a positive refractive power;
a second lens having a negative refractive power;
a third lens having a positive refractive power;
a fourth lens having a positive refractive power; and
a fifth lens having a negative refractive power,
wherein at least one of the first lens to the fifth lens has a free-form surface,
wherein the camera optical lens satisfies a following condition:
R4≤0,
where R4 is a central curvature radius of an image side surface of the second lens.

2. The camera optical lens as described in claim 1, further satisfying a following condition:
1.50≤d5/d4≤11.00,
where d4 is an on-axis distance from the image side surface of the second lens to an object side surface of the third lens, and d5 is an on-axis thickness of the third lens.

3. The camera optical lens as described in claim 1, further satisfying following conditions:
0.48≤f1/f≤1.51;
−3.74≤(R1+R2)/(R1−R2)≤−1.02; and
0.05≤d1/TTL≤0.21,
where f is a focal length of the camera optical lens, f1 is a focal length of the first lens, R1 is a central curvature radius of an object side surface of the first lens, R2 is a central curvature radius of an image side surface of the first lens, d1 is an on-axis thickness of the first lens, and TTL is a total optical length from the object side surface of the first lens to an image plane of the camera optical lens along an optic axis.

4. The camera optical lens as described in claim 1, further satisfying following conditions:
−4.62≤f2/f≤−1.29;
−3.06≤(R3+R4)/(R3−R4)≤−0.73; and
0.02≤d3/TTL≤0.07,
where f is a focal length of the camera optical lens, f2 is a focal length of the second lens, R3 is a central curvature radius of an object side surface of the second lens, d3 is an on-axis thickness of the second lens, and TTL is a total optical length from an object side surface of the first lens to an image plane of the camera optical lens along an optic axis.

5. The camera optical lens as described in claim 1, further satisfying following conditions:
1.27≤f3/f≤6.73;
−3.58≤(R5+R6)/(R5−R6)≤−0.07; and
0.04≤d5/TTL≤0.24,
where f is a focal length of the camera optical lens, f3 is a focal length of the third lens, R5 is a central curvature radius of an object side surface of the third lens, R6 is a central curvature radius of an image side surface of the third lens, d5 is an on-axis thickness of the third lens, and TTL is a total optical length from an object side surface of the first lens to an image plane of the camera optical lens along an optic axis.

6. The camera optical lens as described in claim 1, further satisfying following conditions:
0.53≤f4/f≤5.63;
0.70≤(R7+R8)/(R7−R8)≤2.58; and
0.06≤d7/TTL≤0.19,
where f is a focal length of the camera optical lens, f4 is a focal length of the fourth lens, R7 is a central curvature radius of an object side surface of the fourth lens, R8 is a central curvature radius of an image side surface of the fourth lens, d7 is an on-axis thickness of the fourth lens, and TTL is a total optical length from an object side surface of the first lens to an image plane of the camera optical lens along an optic axis.

7. The camera optical lens as described in claim 1, further satisfying following conditions:
−3.23≤f5/f≤−0.54;
0.89≤(R9+R10)/(R9−R10)≤4.98; and
0.05≤d9/TTL≤0.24,
where f is a focal length of the camera optical lens, f5 is a focal length of the fifth lens, R9 is a central curvature radius of an object side surface of the fifth lens, R10 is a central curvature radius of an image side surface of the fifth lens, d9 is an on-axis thickness of the fifth lens, and TTL is a total optical length from an object side surface of the first lens to an image plane of the camera optical lens along an optic axis.

8. The camera optical lens as described in claim 1, further satisfying a following condition:
TTL/IH≤1.60,
where TTL is a total optical length from an object side surface of the first lens to an image plane of the camera optical lens along an optic axis, and IH is an image height of the camera optical lens.

9. The camera optical lens as described in claim 1, further satisfying a following condition:
FOV≥77°,
where FOV is a field of view of the camera optical lens.

10. The camera optical lens as described in claim 1, further satisfying a following condition:
FNO≤2.21,
where FNO is an F number of the camera optical lens.
